(19) United States
(12) Patent Application Publication
(10) Pub. No.: US 2003/0236792 A1
(43) Pub. Date: Dec. 25, 2003

(54) Method and system for combining multimedia inputs into an indexed and searchable output

(76) Inventors: Donald A. Mangerie, Clarksville, MD (US); Sandra A. Stasko, Ellicott City, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/423,859

(22) Filed: Apr. 28, 2003

Related U.S. Application Data
(60) Provisional application No. 60/375,438, filed on Apr. 26, 2002.

(51) Int. Cl. G06F 7/00

(52) U.S. Cl. 707/100

(57) ABSTRACT

A method, computer program product and system for combining multimedia inputs into an indexed and searchable output is provided. The present invention allows a user to review of an entire (oral) presentation containing several multimedia components (e.g., audio, video, slides, charts, electronic whiteboard, online Web tour, online software demonstration and the like) using only a Web browser, rather than a TV and VCR as is conventionally done. These various multimedia sources are the synchronized to produce an indexed, searchable, and viewable run-time output combining the all of the inputted information. The present invention allows, for example, searching for a particular topic and an immediate review all the slides (and the accompanying video that mentioned that topic), thus enhancing the user's comprehension of the presentation.

This application claims priority from U.S. Provisional Application Serial No. 60/375,438, filed Apr. 26, 2002. The entirety of that provisional application is incorporated herein by reference.

### BACKGROUND OF THE INVENTION

1. Field of the Invention

The present invention relates generally to methods and systems for combining multimedia information, and more particularly to a method and system for combining multimedia input with presentation packages to provide indexed and searchable multimedia information.

2. Related Art

In today's competitive business climate, entities seeking to hire outside contractors to perform a business task or project (e.g., building, maintenance, design, etc.) often review several proposals from competing potential contractors (i.e., bidders) during the selection process before awarding the contract.

During the bidding process, contractors typically are required to submit written proposals to the contract awarding entity (which may be a private or public corporation or a local, state or federal government agency). This is because written proposals are usually easier to evaluate as people (i.e., those making the contractor selection decision for the entity) tend to be more comfortable reviewing text. They can review the text at their own pace and can organize the material to suit their needs. Such reviewers can look at the contractor's written proposal and can cross-reference against other documents such as the Request for Proposal (RFP), Statement of Work (SOW), Proposal Preparation Instructions (PPI) and the Evaluation Criteria.

Often, during the bidding process, contractors may be allowed to make oral presentations to the contract awarding entity. That is, there is a growing trend to use oral presentations as part of the proposal process. This ranges from using oral presentations for the entire proposal, sections of the proposal (e.g., management volume), or simply providing a roadmap to the layout and structure of a contractor's written proposal. Such oral proposals provide reviewers with several advantages over written proposals, including the ability to: (1) ask questions and seek clarifications; (2) hold face-to-face meeting with the team that will be working on the project, rather than reviewing text often written by professional proposal teams; (2) quickly and more confidently evaluate proposals.

Despite the above-listed advantages, oral proposals are generally more difficult to evaluate than written proposals. A reviewer must simultaneously watch and listen to the presenter, look at a slide being presented, take notes on the hard copy they have in front of them and perhaps glance at other written materials such as the Evaluation Criteria. This becomes a true multi-dimensional experience (i.e., audio, visual and written). It can be very difficult for the average person to be able to quickly and accurately assimilate all this multimedia information and comprehend it in order to make a determination among competing bidders.

More specifically, the reviewer, while listening to the oral presentation, is constantly making assessments (e.g., “Do I understand the material presented?”, “Does it make sense?”, and “Does it agree with the other material presented?”). This is a lot of information for a reviewer to process in real-time and keep in synchronization with a presenter who is trying to go as fast as they can to cover a great deal of information in a limited amount of time. Thus, it is nearly impossible to accurately evaluate an oral proposal in real-time. When the reviewer leaves the room at the end of the presentation, they have typically forgotten half of what was said by the bidder-presenter. After listening to multiple contractors, it becomes increasingly difficult to differentiate between the presentations. As time elapses, the reviewer remembers less and less of what was said during any particular presentation.

As a result of the above-described problem, the reviewer is missing one of the two pieces of the multimedia presentation—the audio, leaving only the hard-copy slides. It is analogous to removing the text from a written proposal and attempting to evaluate it based only on the graphics, charts and diagrams. It becomes very difficult to accurately and completely evaluate an oral proposal. Consequently, the awarding entity will often videotape these oral proposal presentations to assist in later evaluation. In other situations, they may request that the contractor film or videotape the presentations and provide copies of the film or videotape as part of their proposal.

Thus, both entities and bidding contractors have come to depend upon videotaped presentations. A reviewing entity will depends on videotape to supplement their memory, while a bidding contractor will depend on the videotape to accurately tell their story. Unfortunately, videotaping the oral presentations does not meet everyone's needs.

For the contractor, it is difficult to present a quality videotape.

For the reviewers who are present, the room needs to be relatively dark to easily read the projected slides. At the same time, however, the videographer either needs lights to make the slides readable on videotape, or they must spend a lot of pre- and post-production time. To deal with these conflicting needs, contractors often spend large amounts of money on production costs to ensure a high-quality product. Not every contractor has in-house video production staff, thus penalizing smaller contractors. At the same time, when the reviewers perform the filming, it may be difficult to provide a high quality, easily viewed videotape because the reviewing entity (e.g., a local government agency) may not have the resources for performing pre- and post-production for every contractor presentation.

Further, the reviewing entity often receives only a poor quality videotape to supplement the original presentation. It can also be difficult to find a VCR and then search a videotape (or multiple tapes) looking for the video and audio segment that accompanied a particular slide. This approach is very inefficient and very time-consuming when fast-forwarding, reversing and/or replaying a clip to complete an evaluation. It also remains very difficult to determine if a topic was addressed across multiple slides. The reviewer is now stuck in front of a TV and a VCR trying to evaluate the proposal against all the entity's documents which specify the project.

The result of the above-described situation is frustration. Frustration for the reviewer trying to review the spoken word and hard copy slides against the their requirements. And, frustration for the bidder-contractor during their debrief because they may not receive an accurate evaluation.

Therefore, given the above, what is needed is a method, computer program product and system for combining several multimedia inputs into an indexed and searchable output. The output should support quicker and more accurate evaluations by providing readable slides synchronized with the appropriate video or audio.

### SUMMARY OF THE INVENTION

The present invention meets the above-identified needs by providing a method, computer program product and system for combining multimedia inputs into an indexed and searchable output.

The present invention allows the inputting of multimedia and other information, including, for example, input from a presentation package such as Microsoft® PowerPoint®, available from Microsoft Corporation of Redmond, Wash., and synchronizing and indexing the input information to produce an indexed, searchable, and viewable run-time output combining the inputted information. The present invention allows a review of an entire oral presentation using only a Web browser rather than finding a TV and VCR and using a remote control to view the entire presentation. The present invention allows searching for a particular topic and an immediate review all the slides (and the accompanying video that mentioned that topic), thus enhancing evaluations.

In an embodiment, the method and computer program product of the present invention includes the steps of capturing a plurality of multimedia inputs related to an event, wherein each of the plurality of multimedia inputs is time stamped, and creating a metadata file representing the captured and time-stamped inputs. Next, supplemental information related to the inputs is received, wherein the supplemental information establishes a link between the inputs and any external multimedia source. A time line is then created that integrates and synchronizes the multimedia inputs. A formatted file, using the time line, is then created that contains the integrated and synchronized multimedia inputs and the supplemental information. The result is that a user can view and search any segment of the event “on-demand” due to the indexed and searchable output produced by the present invention.

An advantage of the present invention is that it improves the oral proposal review process, resulting in increased productivity and time savings.

Another advantage of the present invention is that it reduces the time required to review oral proposals and provide more accurate scores to competing (bidding) contractors.

Another advantage of the present invention is that the indexed and searchable output can be in the form of a searchable CD-ROM disc available within minutes of the completion of a bidder-contractor's presentation.

Yet other advantages of the present invention is that it provides the ability to capture an online demonstration such as a Web tour and link it to an individual slide for playback, provides a user interface for linking additional information to individual slides, allows a user to change the speed of the playback and provides the ability to distribute the synchronized presentation via a Web server.

Yet another advantage of the present invention is that it may be utilized by an entity (e.g., management) as a low-risk, low-cost, solution for bringing meetings, seminars, conferences and training courses to its personnel (e.g., employees).

Yet another advantage of the present invention is that it provides a user with the ability to view an event (e.g., a presentation or training course) either live, on-demand, or to search and view any segment of the event.

Further features and advantages of the invention as well as the structure and operation of various embodiments of the present invention are described in detail below with reference to the accompanying drawings.

### BRIEF DESCRIPTION OF THE FIGURES

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram illustrating a multimedia system environment in which the present invention would operate to create an output file in an embodiment.

FIG. 2 is a block diagram illustrating a multimedia system environment in which the present invention would operate to view an output file according to an embodiment.

FIG. 3 is a block diagram illustrating a multimedia system environment in which the present invention would operate to view an output file according to an embodiment.

FIG. 4 is a master time line for integrating and synchronizing information objects according to an embodiment of the present invention.

FIG. 5 is an XML file created during the operation of the present invention, in an embodiment, which includes all the information objects time synchronized with the time code of video/audio for an event.

FIG. 6 is a flowchart illustrating the operation of the present invention according to one embodiment.

FIG. 7 is a block diagram of an exemplary computer system useful for implementing the present invention.

FIGS. 8A-K are exemplary windows or screen shots generated by the graphical user interface of the present invention according to one embodiment.

### DETAILED DESCRIPTION

Overview

The present is directed to a method, computer program product and system for combining several multimedia inputs into an indexed and searchable output.

In an embodiment, a contractor bidding on a project gives a multimedia presentation (i.e., a presentation involving a human presenter interacting with text, graphics, voice and/or video) to one or more reviewers. The presentation is filmed or videotaped. The text from any slides are then extracted and indexed, and then synchronized with the video ensuring time accurate synchronization. The resulting output is an indexed, searchable and viewable run-time output produced within minutes of the completion of the presentation.

More specifically, In such an embodiment, the video and audio of the presenter and their slides, whiteboards, on-line demonstrations, documents, Web pages and other types of information are integrated and synchronized into one solution that can be provided on CD-ROM disc for users (e.g., contractor proposal reviewers, trainees and the like) to view or be viewed via the Web. This improves the experience for the attendees and dramatically improves information retention. It also provides the opportunity for more people to attend and gain the presentation or learning experience. In an embodiment, the present invention provides an eXtensible Markup Language (XML)-based solution, so that all of the information, including the video and the contents of the slides can be searchable. The present invention's solution can be integrated into existing solutions, thus this information can be made searchable using existing organizational search and retrieval systems.

The present invention is described below in greater detail in terms of the above example. This is for convenience only and is not intended to limit the application of the present invention. In fact, after reading the following description, it will be apparent to one skilled in the relevant art(s) how to implement the following invention in alternative embodiments. For example, the present invention may be utilized by trainers (as presenters) and trainees (as attendees), rather than by contractors and reviewers, respectively.

The terms “user,” “trainee,” “reviewer,” “entity,” “company,” and the plural form of these terms are used interchangeably throughout herein to refer to those who would access, use, and/or benefit from the tool that the present invention provides for combining several multimedia inputs into an indexed and searchable output.

An example of a method computer program product and system for inputting, combining, indexing, and producing an output file, such as an EXtensible Markup Language (XML) file, for use by a viewing user, in accordance with an embodiment of the present invention will now be described.

System Architecture

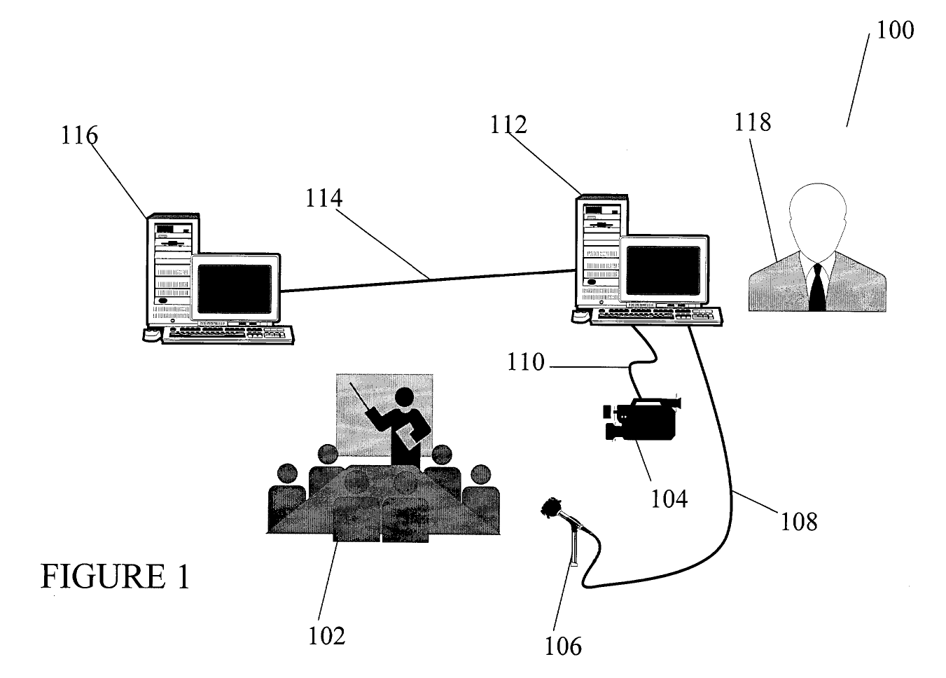

Referring to FIG. 1, a block diagram is shown that illustrates a multimedia system environment 100 in which the present invention would operate to create an output file in an embodiment.

System 100 includes a source of multimedia information 102 (e.g., a presenter at a conference, a contractor at a bidding oral presentation or the like) that provides multimedia information for input via one or more multimedia input devices. Such multimedia input devices may include, in an embodiment, a video input device 104 and an audio input device 106 for inputting video and audio information, respectively, from multimedia source 102.

In an embodiment, the inputted multimedia information is transmitted via couplings 108 and 110, to a processing terminal 112, such as personal computer (PC) (e.g., an IBM® or compatible PC workstation running the Microsoft® Windows 95/98® or Windows NT® operating system, Macintosh® computer running the Mac® OS operating system, or the like). In alternate embodiments, processing terminal 112 is any processing device having a processor and a display including, but not limited to, or a minicomputer, microcomputer, mainframe computer, laptop, palmtop, workstation, set-top box, or personal digital assistant (PDA).

Many other sources of and input devices for multimedia information are also usable in conjunction with the present invention. For example, multimedia source 102 may be a prerecorded video or audio presentation transmitted to processing terminal 112 from any source via a network, such as the global, public Internet.

In the present embodiment, system 100 also includes a presentation device 116 which is also coupled to processing terminal 112 via coupling 114. That is, for example, if multimedia source 102 includes a speaker giving a presentation, the presentation information may include a (PowerPoint) slide presentation displayed on a screen from a terminal, which together comprise the presentation device 116. Thus, output from presentation device 116, such as a feed of the presentation information, is transmitted to processing terminal 112 via coupling 114.

In an embodiment, couplings 108, 110 and 114 are, for example, wired, wireless, or fiberoptic communication links.

Within system 100, a host operator 118 uses a graphical user interface (GUI) on processing terminal 112 to combine the input from presentation device 116 and from video input device 110 and/or an audio input device 106 to produce, for example, a run-time file or other file containing the input information. At processing terminal 112, additional information is optionally input, such as speaker names and scanned input that is not otherwise available electronically. The information may then be linked, such as by synchronizing the presentation information to the input multimedia information for simultaneous display in the run-time or other file. Thus, for example, selection by a viewing user of the run-time or other file of a particular slide in a presentation changes the multimedia information display to the synchronized corresponding point in the multimedia information display when the slide was presented in the presentation.

Because, for example, the run-time or other file includes textual and/or other searchable input information, such as information input by host operator 118 or text information input with the presentation information, searching and indexing options are available for the file produced. In an embodiment of the present invention, the GUI allows host operator 118 to vary the presentation format of the information displayed in the run-time or other file. For example, host operator 118 can vary the inclusion or positioning of the multimedia display in a window relative to the presentation information display, and include textual explanation and a clock for time elapsed and/or other relative point in file information in the multimedia display.

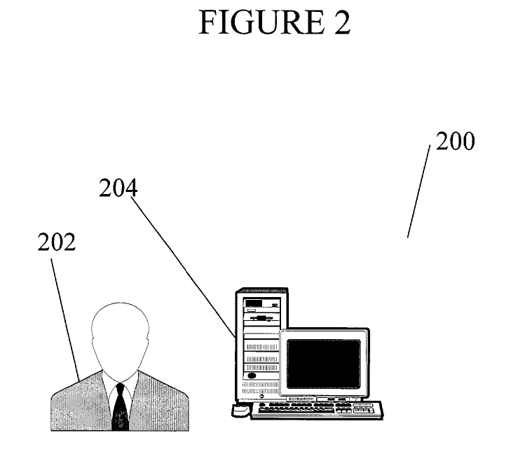

Referring to FIG. 2, a block diagram is shown that illustrates a multimedia system environment 200 in which the present invention would operate to view an output file according to an embodiment. System 200 includes a viewing user 202 who would access and view the output file produced in accordance with embodiments of the present invention. In system 200, the file produced is opened and viewed by viewing user 202 via a user terminal 204. The file produced is, for example, stored on a compact disk (CD) and read by a CD player within or via user terminal 202. As will be apparent to one skilled in the relevant art(s) after reading the description herein, system 200 can represent a “stand alone” version of the present invention.

In alternate embodiments, user terminal 204 is any processing device having a processor, a display and access to non-volatile memory on which the output file of the present invention is stored, including, but not limited to, or a PC, minicomputer, microcomputer, mainframe computer, laptop, palmtop, workstation, set-top box, or personal digital assistant (PDA).

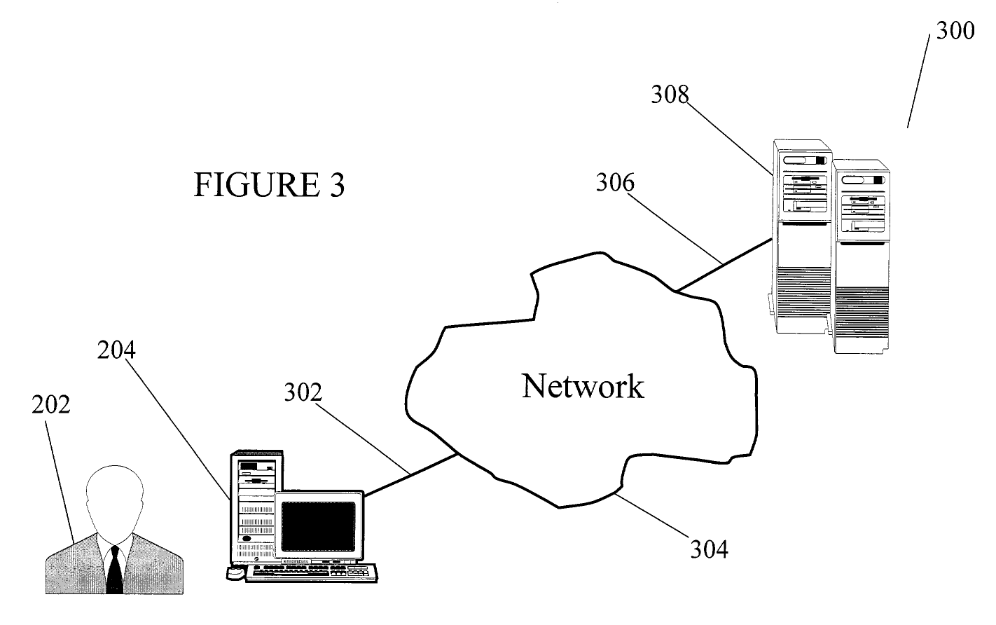

Referring to FIG. 3, a block diagram is shown that illustrates a multimedia system environment 300 in which the present invention would operate to view an output file according to an embodiment. System 300 includes viewing user 202 who would access and view the output file produced in accordance with embodiments of the present invention. In system 300, is opened and viewed by viewing user 202 via user terminal 204. The file produced is stored in a server 308, such as a workstation (e.g., Sun or NT workstation), minicomputer, microcomputer, main frame computer, or other processor. Server 308 is coupled via coupling 40 and 42 to a network 304, such as the global, public Internet, internet, or an intranet, local area network (LAN) or wide area network (WAN) to user terminal 204 for viewing user 202 to access and view the output file stored on server 308. As will be apparent to one skilled in the relevant art(s) after reading the description herein, system 300 can represent a “networked” or “enterprise” version of the present invention.

More detailed descriptions of system 100, 200 and 300 components, as well their functionality, are provided below.

Software Architecture

As mentioned above, in an embodiment, the video and audio of the presenter, slides, whiteboards, on-line demonstrations, documents, Web pages and other types of information are integrated and synchronized into one solution that can be provided on CD-ROM disc (or any other non-volatile memory means) to users.

In an embodiment, each type of information (e.g., video, audio, slides, text document, Web page, etc.) is an “information object.”

An “event” (e.g., training course, seminar, conference, contractor presentation, etc.) is defined as a collection of synchronized information objects. Each information object is further defined by a set of metadata.

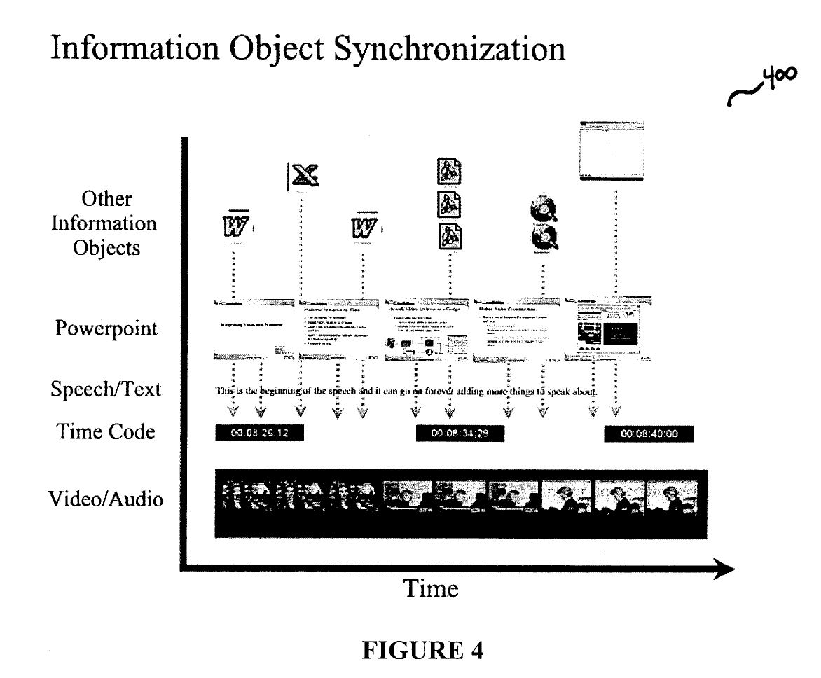

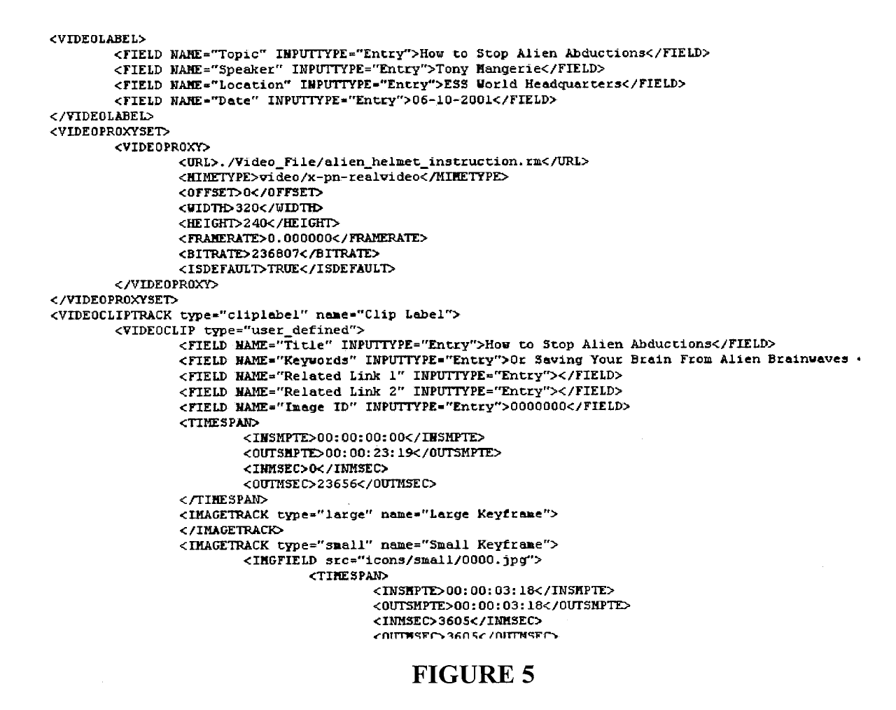

In an embodiment, the present invention relies on the assumption that events are intrinsically multimedia-based. That is, it is assumed the event contains a video or audio information object. Thus, a timecode contained within the video or audio is utilized to create a master time line for integrating and synchronizing other information objects. A master time line 400 is shown in FIG. 4. Time line 400 allows accurate synchronization of the other information objects within the event. An XML file is then created which includes all the information objects time synchronized with the time code of the video/audio. An XML file 500 is shown in FIG. 5. XML file 500 would contain the text of any slides or any other information objects. XML file 500 also accurately depicts the multimedia synchronization for replay by users. XML file 500 can also be thought of as containing “clips” which are hierarchical in nature and can represent information segments such as lessons, topics or even individual slides.

Operation

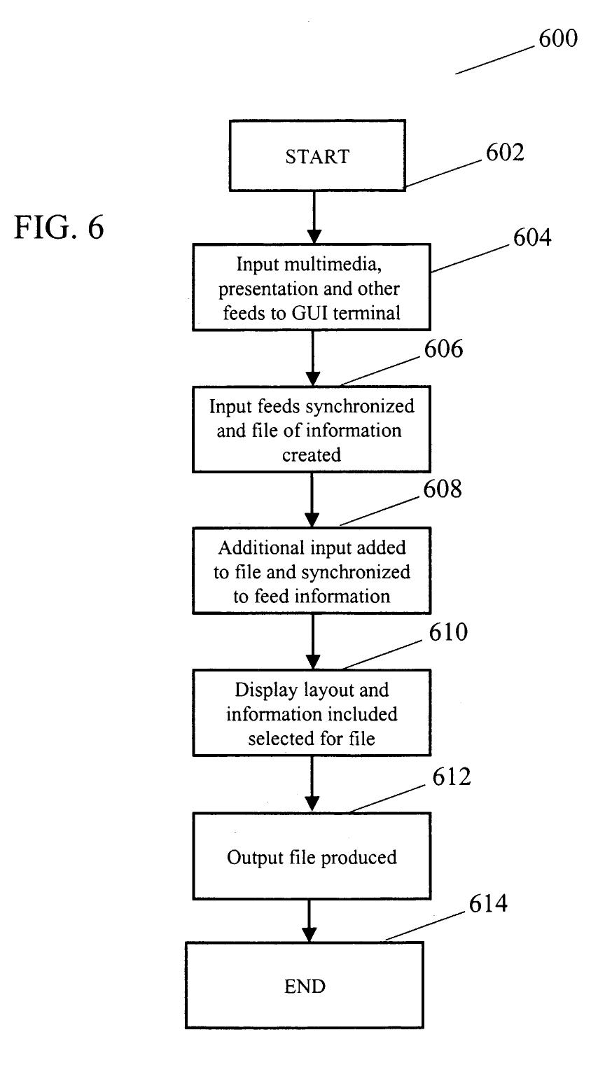

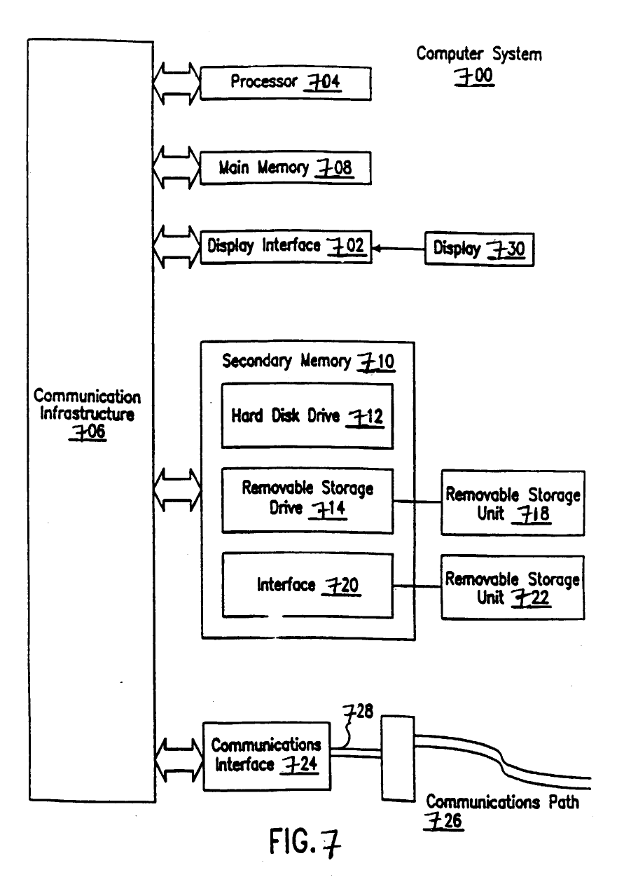

Referring to FIG. 6, a flowchart illustrating a process of inputting and producing a file from multimedia and other input information 600, according to an embodiment of the present invention, is shown. Process 600 begins at step 602 with control passing immediately to step 604.

In step 604, an event (e.g., a contractor oral presentation) is first captured. That is, a host operator 118 would use the GUI of terminal 112 to capture the presentation event being delivered by multimedia source (i.e., speaker) 102. Terminal 112 would capture and digitize the video stream from video input device 104 and the audio stream from audio source 106.

In an embodiment, when there are multiple sources of input (e.g., an electronic whiteboard, online Web tour, online software demonstration and the like), output from such multimedia inputs are captured by terminal 112 from one or more presentation devices 116. In an alternate embodiment, multiple terminals 112 may be employed each equipped with a video capture card for each additional video input (e.g., an electronic whiteboard, online Web tour, online software demonstration and the like) utilized by speaker 102 during the presentation event. Such video capture cards would encode and digitize the signal for eventual streaming utilizing commercially available streaming applications formats, such as those available from RealNetworks, Inc. of Seattle, Wash. and Microsoft Corp. of Redmond, Wash., for delivery to viewing users 202.

More specifically, as presenter 102 begins speaking, terminal(s) 112 containing the video feeds are started as they are used by presenter 102. For example, when speaker 102 begins their presentation, terminal 112 that is receiving the video/audio is started by operator 118 and the video/audio is digitized for eventual delivery. At the same time, software code logic residing on presentation device 116 is started thus synchronizing the two inputs (i.e., presenter video/audio and, for example, a PowerPoint presentation slide). If presenter 102 uses other sources such as a whiteboard, then that presentation device 116 is also started to digitize that particular input. It is stopped when presenter 102 stops using that source. As presenter 102 changes slides, the time that each slide or slide transition occurs is captured by terminal 112. Thus, later synchronization of the PowerPoint slides with the video is possible.

In step 606, metadata is extracted from the multimedia captured during the presentation and a single XML metadata file is created that contains time synchronized information. That is, the XML metadata file contains an XML tag that represents each slide. This contains the title and text on the slide, an image of the slide along with the start time and stop time for each slide. There is also an XML tag that contains a link to the digitized video file so that the XML file is related to the correct video file.

In step 608, supplemental and/or supporting information is added to the XML file. That is, the XML file is edited to synchronize any other multimedia input sources (e.g., other video feeds). For example, if at “slide number 3” during the presentation event, presenter 102 walked up to a whiteboard and drew a diagram to further describe that slide. A link is then provided within the set of tags relating to “slide number 3” that point to the video of the whiteboard along with the start time of the whiteboard video. Thus, in the eventual output file this whiteboard video can be replayed at the specific time of“slide number 3.” In an embodiment, links to other related materials can be provided. For example, at slide number 4, presenter 102 may have referenced a document that contains supplemental information. Within the set of XML tags for slide number 4, a link to an external document is provided. At the completion of step 608, all information related to the presentation event is time synchronized a time line 400 of the video/audio of presenter 102. This allows accurately replay the entire presentation.

In step 610, eXtensible Stylesheet Language (XSL) style sheets are applied to the XML metadata files to display the metadata synchronized to the video/audio of the presentation event. (As will be appreciated by those skilled in the relevant art(s), an XSL style sheet is a file that describes how to display an XML document of a given type.) That is, a determination is made as to the delivery mechanism for the presentation event. In alternate embodiments, the indexed and searchable output of the present invention is a CD-ROM, a Web presentation in XML format or a Web presentation in Hypertext Markup Language (HTML) format. A directory structure is then created with the appropriate supporting files for the selected delivery format. This consists of the master XML file with tags for all related information, video files, electronic images of any PowerPoint presentation slides and any other related information.

In step 612, the indexed and searchable output created by the present invention is written to the appropriate file system for eventual use by viewing user 202. That is, the output directory is uploaded to a Web server (e.g., server 308 via FTP) if Web delivery was selected (in step 610) or written to a CD-ROM if such delivery was selected (in step 610).

Process 600 then ends as indicated by step 614.

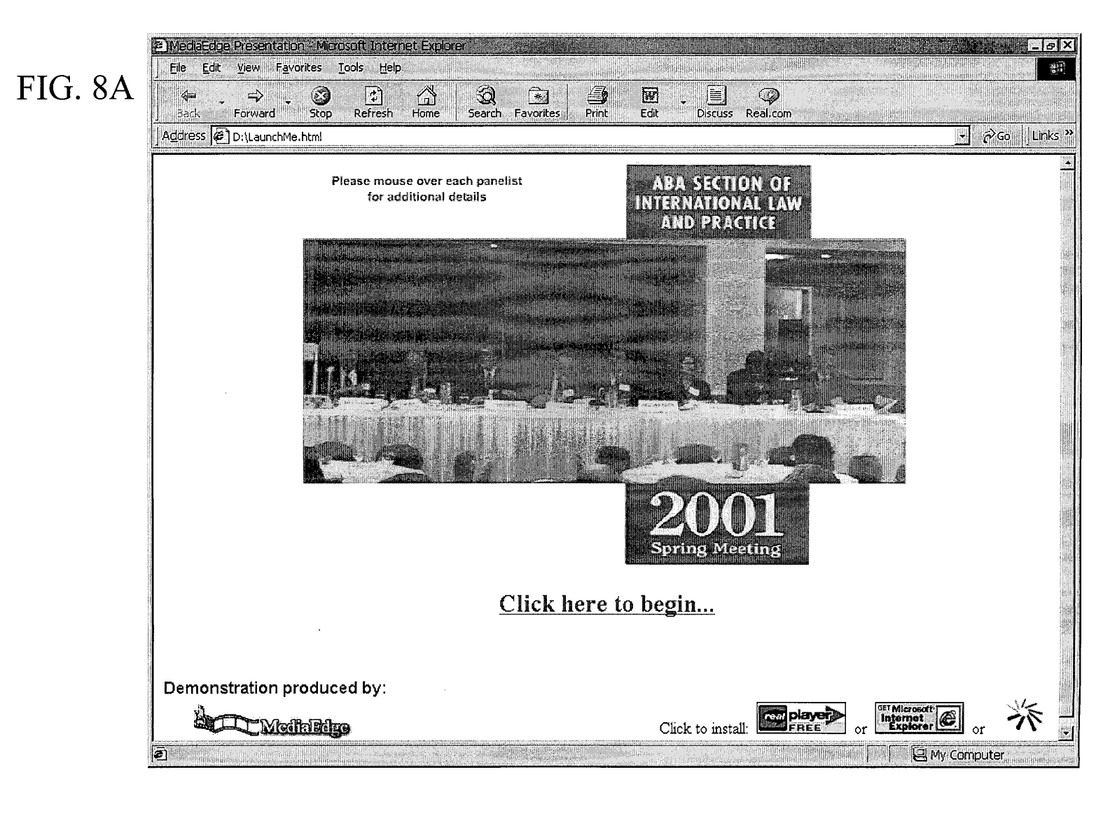

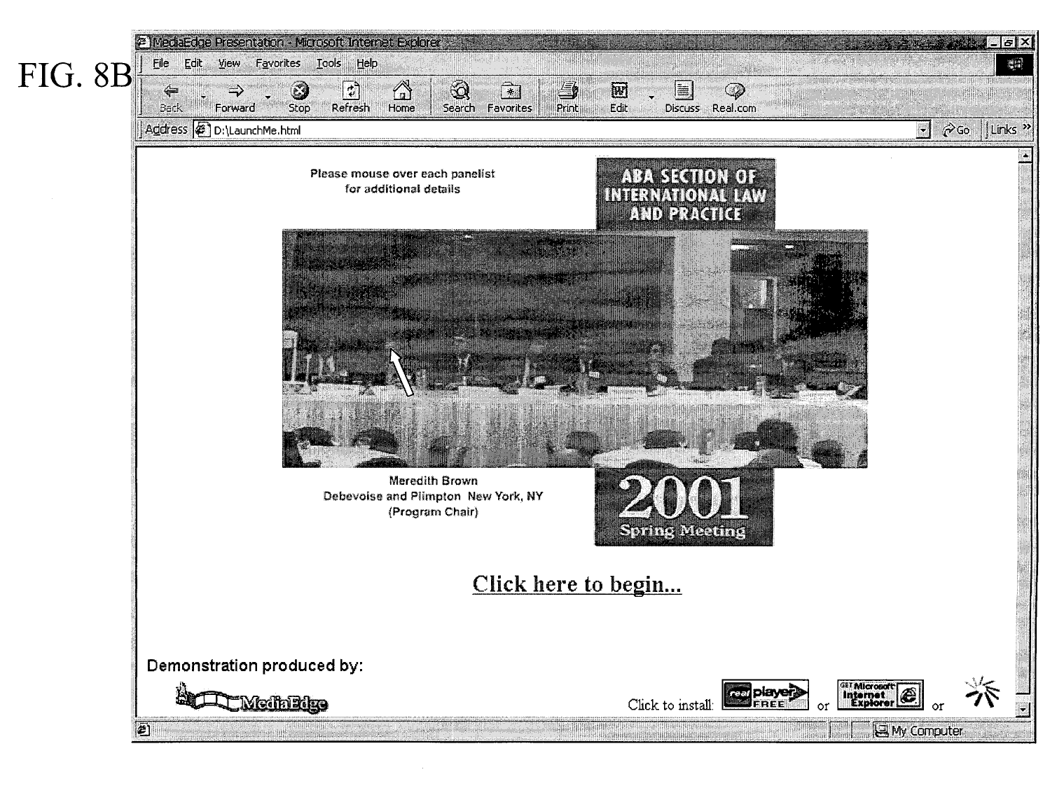

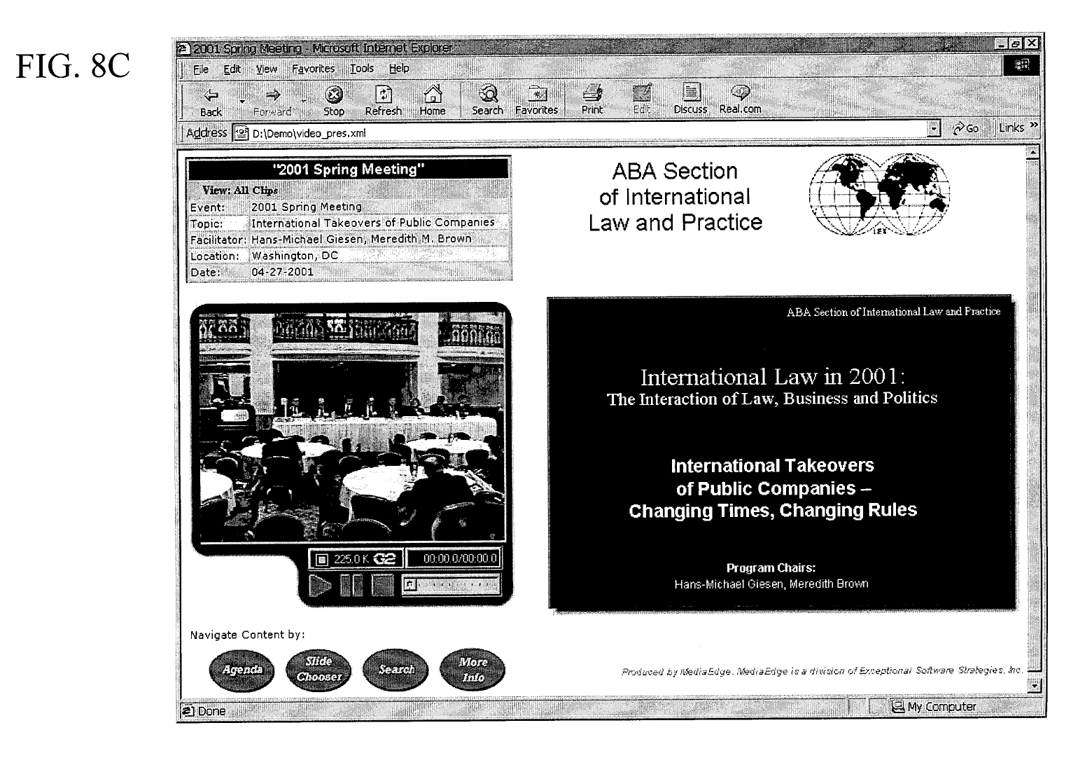

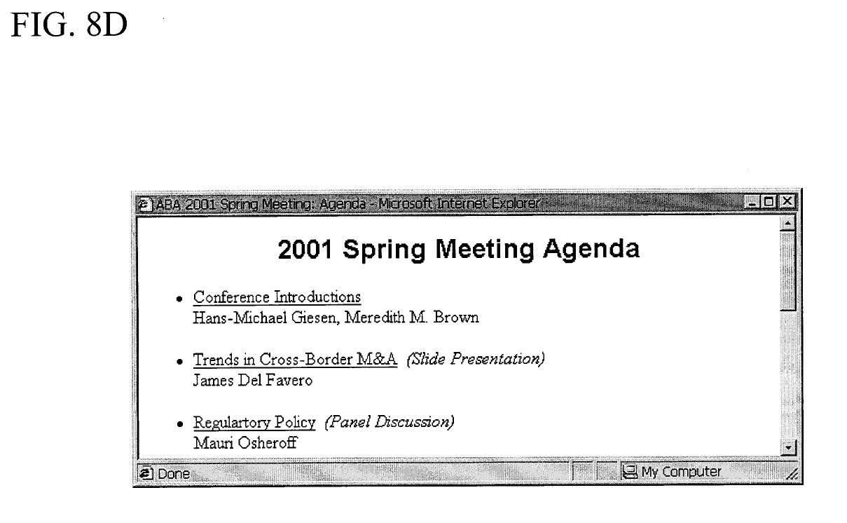

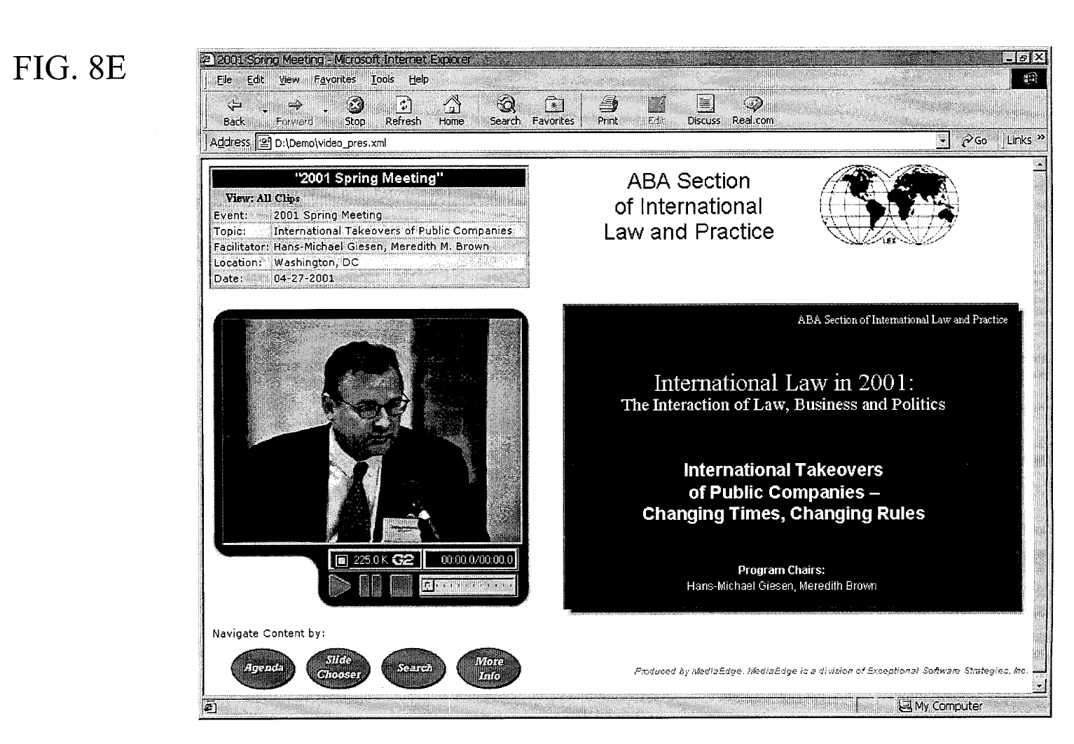

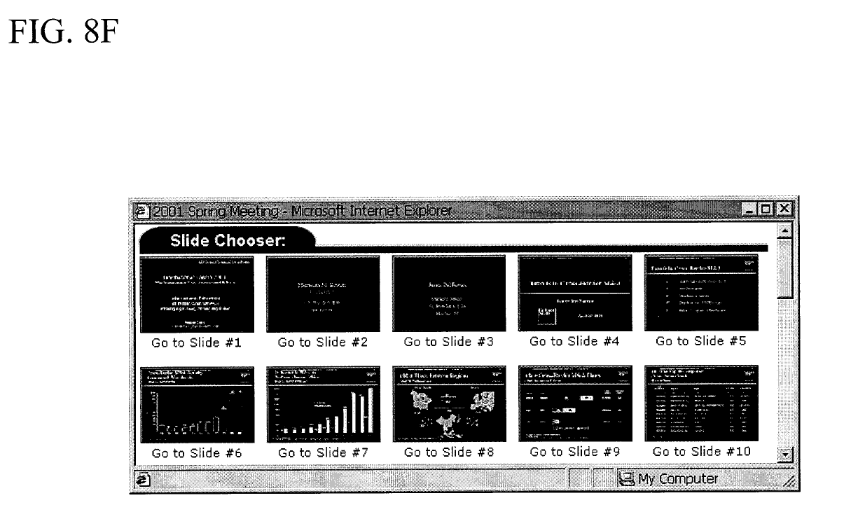

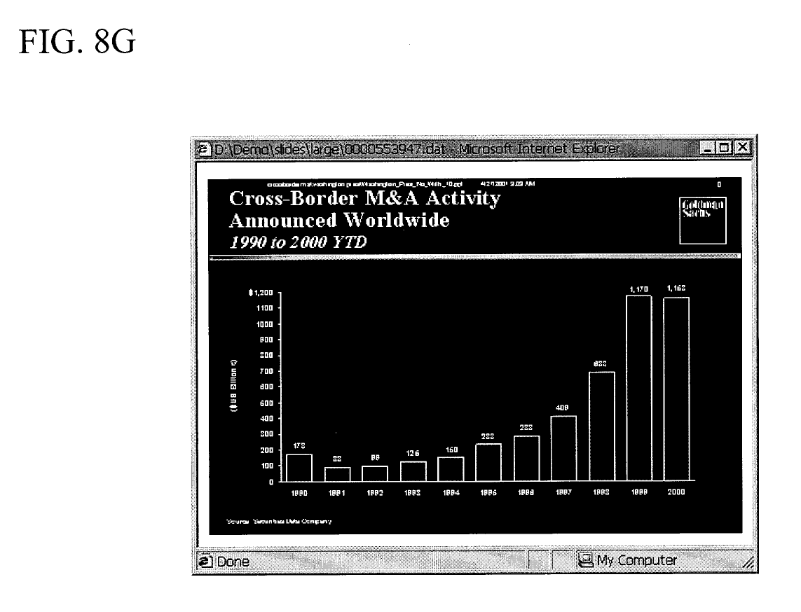

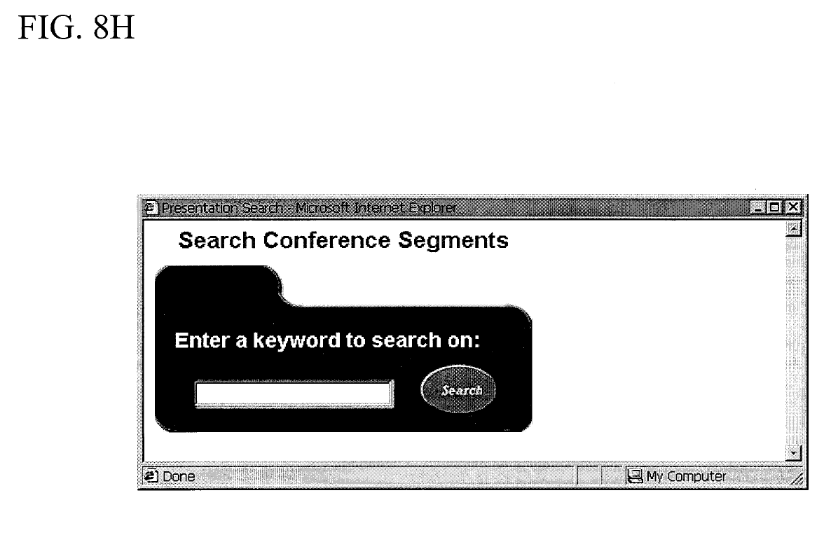

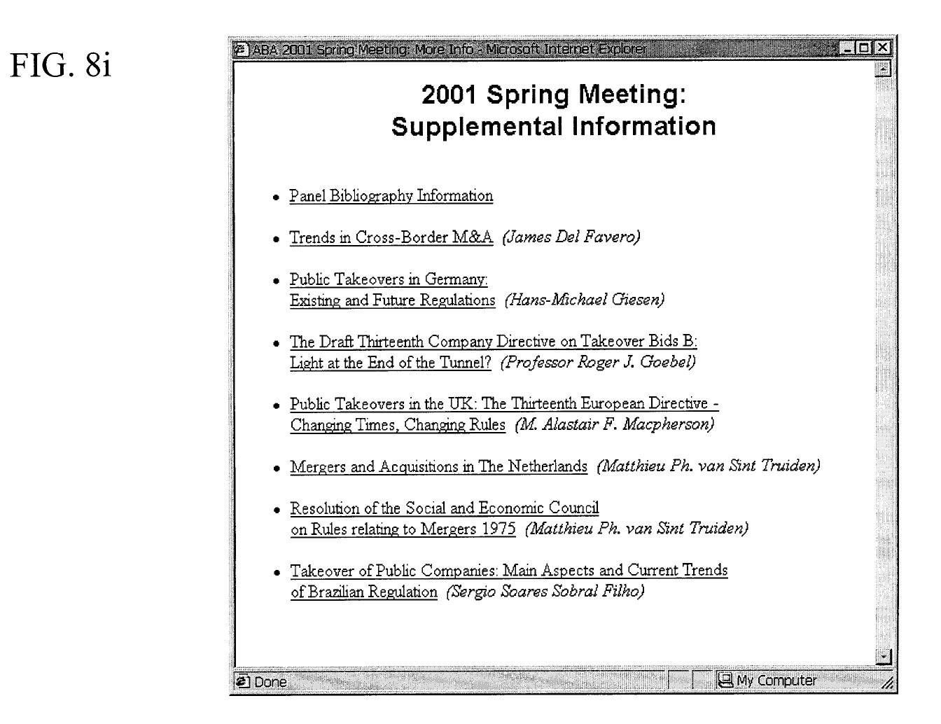

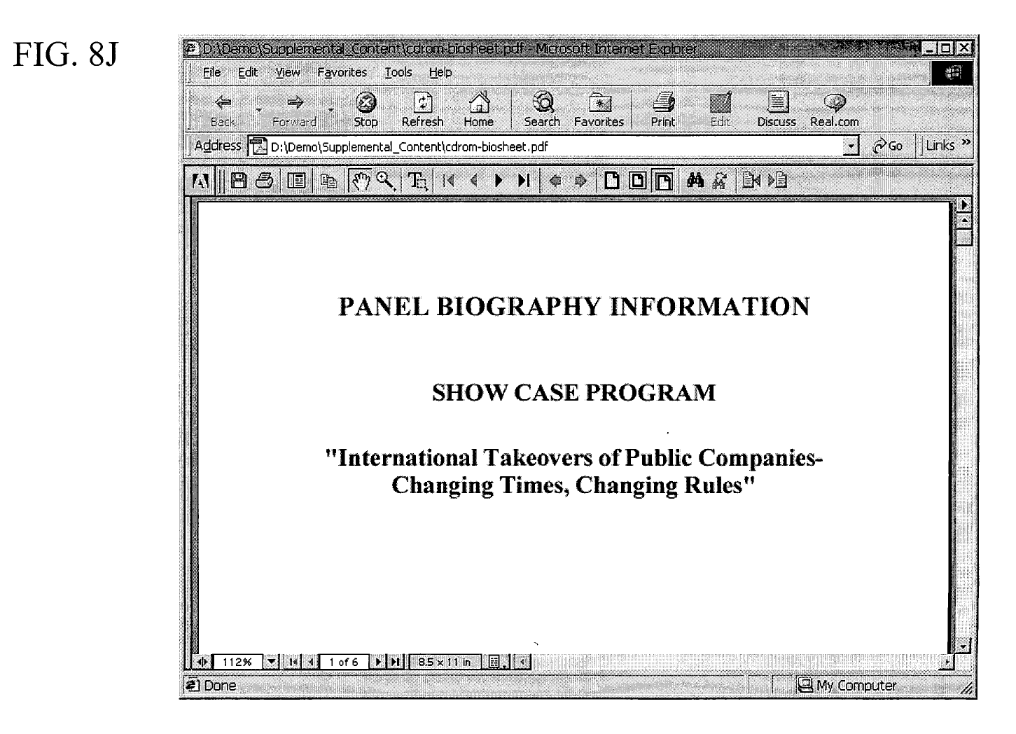

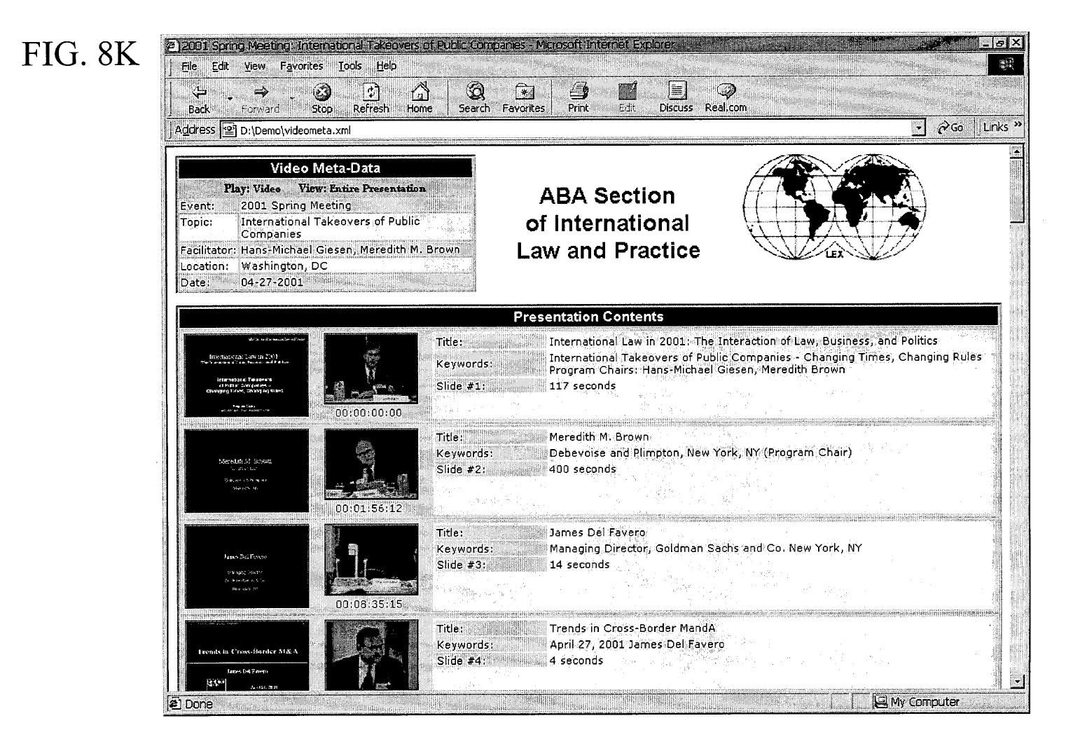

Referring to FIGS. 8A-K, exemplary windows or screen shots generated by the graphical user interface of the present invention for a particular presentation event are shown. It should be understood that the screens shown herein, which highlight the functionality of system 100 and operation of process 600, are presented for example purposes only. The software architecture (and thus, GUI screens) of the present invention is sufficiently flexible and configurable such that users 202 may replay (and navigate through) events in a manner other than those shown in FIGS. 8A-K.

Example Implementations

The present invention (i.e., systems 100-300, process 600, and/or any part(s) or function(s) thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 700 is shown in FIG. 7. The computer system 700 includes one or more processors, such as processor 704. The processor 704 is connected to a communication infrastructure 706 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 700 can include a display interface 705 that forwards graphics, text, and other data from the communication infrastructure 702 (or from a frame buffer not shown) for display on the display unit 730.

Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718 represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a PCMCIA slot and card, etc. Software and data transferred via communications interface 724 are in the form of signals 728 which may be electronic, electromagnetic, optical or other signals capable of being received by communications interface 724. These signals 728 are provided to communications interface 724 via a communications path (i.e., channel) 726. This channel 726 carries signals 728 and may be implemented using wire or cable, fiber optics, a phone line, a cellular phone link, an RF link and other communications channels.

In this document, the terms “computer program medium” and “computer usable medium” are used to generally refer to media such as removable storage drive 714, a hard disk installed in hard disk drive 712, and signals 728. These computer program products are means for providing software to computer system 700. The invention is directed to such computer program products.

Computer programs (also called computer control logic) are stored in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform the features of the present invention. Accordingly, such computer programs represent controllers of the computer system 700.

In an embodiment where the invention is implemented using software, the software may be stored in a computer program product and loaded into computer system 700 using removable storage drive 714, hard drive 712 or communications interface 724. The control logic (software), when executed by the processor 704, causes the processor 704 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method for presenting a multimedia-based event to a user, comprising the steps of:
collecting a plurality of information objects which comprise an event;
synchronizing said plurality of information objects of said event;
creating a metadata file from said synchronized plurality of information objects; and
storing said metadata file onto a viewable medium;
wherein a user may view and search any segment of the event on-demand from said viewable medium.

2. The method of claim 1, wherein said metadata file is an eXtensible Markup Language (XML) file.

3. The method of claim 1, wherein said viewable medium is a CD-ROM.

4. The method of claim 1, wherein said viewable medium is a Web presentation in eXtensible Markup Language (XML) format.

5. The method of claim 1, wherein said viewable medium is a Web presentation in Hypertext Markup Language (HTML) format.

6. A method for combining multimedia inputs of an event into an indexed and searchable output, comprising the steps of:
capturing a plurality of multimedia inputs related to an event, wherein each of said plurality of multimedia inputs is time stamped;
creating a metadata file representing said captured and time-stamped plurality of multimedia inputs;
receiving supplemental information related to at least one of said plurality of multimedia inputs, wherein said supplemental information establishes a link between said one of said plurality of multimedia inputs and another multimedia input;
creating a time line that integrates and synchronizes said plurality of multimedia inputs; and
creating a formatted file, using said time line, containing said integrated and synchronized plurality of multimedia inputs and said supplemental information.

7. The method of claim 6, further comprising the step of:
applying an eXtensible Stylesheet Language (XSL) style sheet to said metadata file in order to display said synchronized plurality of multimedia inputs.

8. The method of claim 6, wherein said metadata file is an eXtensible Markup Language (XML) file.

9. The method of claim 6, further comprising the step of:
displaying said formatted file to user in the form of a Web presentation, whereby said user may view and search any segment of the event on-demand.

10. The method of claim 9, wherein said formatted file in a Hypertext Markup Language (HTML) file.

11. The method of claim 9, wherein said formatted file is an eXtensible Markup Language (XML) file.

12. The method of claim 6, wherein said supplemental information is a reference to an external document.

13. A computer program product comprising a computer usable medium having control logic stored therein for causing a computer to combine multimedia inputs of an event into an indexed and searchable output, said control logic comprising:
first computer readable program code means for causing the computer to capture a plurality of multimedia inputs related to an event, wherein each of said plurality of multimedia inputs is time stamped;
second computer readable program code means for causing the computer to create a metadata file representing said captured and time-stamped plurality of multimedia inputs;
third computer readable program code means for causing the computer to receive supplemental information related to at least one of said plurality of multimedia inputs, wherein said supplemental information establishes a link between said one of said plurality of multimedia inputs and another multimedia input;
fourth computer readable program code means for causing the computer to create a time line that integrates and synchronizes said plurality of multimedia inputs; and
fifth computer readable program code means for causing the computer to create a formatted file, using said time line, containing said integrated and synchronized plurality of multimedia inputs and said supplemental information.

14. The computer program product of claim 13, wherein said metadata file is an eXtensible Markup Language (XML) file.

15. The computer program product of claim 13, further comprising the step of:
displaying said formatted file to user in the form of a Web presentation, whereby said user may view and search any segment of the event on-demand.

16. The computer program product of claim 15, wherein said formatted file in a Hypertext Markup Language (HTML) file.

17. The computer program product of claim 15, wherein said formatted file is an eXtensible Markup Language (XML) file.

18. A computer program product comprising a computer usable medium having control logic stored therein for causing a computer to present a multimedia-based event to a user, said control logic comprising:
first computer readable program code means for causing the computer to collect a plurality of information objects which comprise an event;
second computer readable program code means for causing the computer to synchronize said plurality of information objects of said event;
third computer readable program code means for causing the computer to create a metadata file from said synchronized plurality of information objects; and
fourth computer readable program code means for causing the computer to store said metadata file onto a viewable medium;
wherein a user may view and search any segment of the event on-demand from said viewable medium.

19. The computer program product of claim 18, wherein said metadata file is an eXtensible Markup Language (XML) file.
